(19) United States
(12) Patent Application Publication
(10) Pub. No.: US 2014/0304253 A1
(43) Pub. Date: Oct. 9, 2014

(54) SCREEN-DATA EDITING DEVICE FOR PROGRAMMABLE DISPLAY DEVICE

(71) Applicant: Yukihiro Hanaki, Nagoya-shi (JP)

(72) Inventor: Yukihiro Hanaki, Nagoya-shi (JP)

(73) Assignee: MITSUBISHI ELECTRIC CORPORATION, Chiyoda-ku, Tokyo (JP)

(21) Appl. No.: 13/521,663

(22) PCT Filed: Dec. 7, 2011
(86) PCT No.: PCT/JP2011/078338

§ 371 Date: Jul. 11, 2012

(51) Int. Cl. G06F 17/30

(52) U.S. Cl. CPC G06F 17/30106
USPC 707/722

(57) ABSTRACT

A screen-data editing device for a programmable display device includes: a display-device information management unit that reads from a programmable display device, display-device main-unit information indicating a history of information externally output from the programmable display device and display-device operation-history information indicating a history of operations performed for the programmable display device, extracts a reserved word contained in those two types of information, and creates two types of data base having a plurality of records each containing a field for a search key corresponding to the reserved word. The device also includes a display-device-information search unit that extracts from the display-device operation-history information database, and a search-result display unit (101e) that displays on a display unit (105) as an operation history list.

### FIELD

The present invention relates to a screen-data editing device for a programmable display device.

### BACKGROUND

When some trouble occurs in a programmable display device or in a device or a system using the programmable display device, a person who checks the cause of the trouble assumes and analyzing the cause by manually obtaining several kinds of information himself, such as programmable-display-device operation-history information and project data of a display device, from the programmable display device or a computer and comparing the obtained information to each other, in order to detect the cause of the trouble and consider a preventive measure against the trouble.

Due to this fact, it usually takes time to obtain a position where the trouble has occurred and detailed information regarding parts in project data related to the trouble, so that speedy searching for the cause has been prevented.

Patent Literature 1 discloses a technique that enables to register comments and the like regarding parts as related information and display the information together with the parts.

### CITATION LIST

### Patent Literature

Patent Literature 1: Japanese Patent Application Laid-open No. 2011-086118

### SUMMARY

### Technical Problem

When some trouble occurs in a main unit of the programmable display device or in a device or a system using the programmable display device, how quickly the trouble can be solved becomes an important issue.

Under these circumstances, to diagnose the cause of a trouble, programmable-display-device main-unit information is obtained manually, then the project data or related design materials are searched for information related to the trouble, and the cause of the trouble is analyzed based on the obtained information. However, persons other than the designer involved in that system cannot speedily cope with the quest for the information because they have little knowledge of the system and a project data configuration. Particularly, in a case of a device or a system that has been running for a long time, information is often insufficient because its designer is no longer present or related design materials have been lost, which disadvantageously requires a lot of time and labor to collect information for searching the cause.

According to the invention disclosed in Patent Literature 1, persons other than the designer also can easily detect the cause by referring to comments; however, when a program itself is long, a user him/herself needs to find out information related to the trouble from randomly enumerated comments. Therefore, the problem that it takes a lot of time and labor to collect the information for searching the cause is not entirely solved.

The present invention has been achieved in consideration of these problems, and an object of the present invention is to obtain a screen-data editing device for a programmable display device that can easily acquire a trouble occurring position and detailed information regarding related parts.

### Solution to Problem

In order to solve the aforementioned problems, a screen-data editing device for a programmable display device that edits screen data of a programmable display device according to one aspect of the present invention is constructed in such a manner that it includes: a display unit that displays information; a display-device-information management unit that reads from the programmable display device, display-device main-unit information indicating a history of information externally output from the programmable display device and display-device operation-history information indicating a history of operations performed with respect to the programmable display device, extracts a reserved word contained in the display-device main-unit information and the display-device operation-history information read from the programmable display device, and creates a display-device main-unit information database and a display-device operation-history information database that have a plurality of records each containing a field for a search key corresponding to the reserved word; a display-device-information search unit that extracts, from the display-device operation-history information database, a record containing a same search key as that contained in a record specified from the display-device main-unit information database through a user's operation; and a search-result display unit that causes the display unit to display as an operation history list, a list of the records extracted from the display-device operation-history information database by the display-device-information search unit.

### Advantageous Effects of Invention

The screen-data editing device for a programmable display device according to the present invention can easily acquire a trouble occurring position and detailed information regarding related parts.

### BRIEF DESCRIPTION OF DRAWINGS

FIG. 1 depicts a configuration of a screen-data editing device for a programmable display device according to an embodiment of the present invention.

FIG. 2 depicts a process of transforming display-device main-unit information read from a programmable display device into a database.

FIG. 3 depicts a process of transforming display-device operation-history information read from the programmable display device into a database.

FIG. 4 depicts a process flow of extracting search key information from the display-device main-unit information or the display-device operation-history information.

FIG. 5 depicts a process flow of searching extracted character strings for a reserved word.

FIG. 6 is an example of a reserved-word search-key map.

FIG. 7 is an example of display on a display unit of information that is obtained from a display-device main-unit information database and a display-device history information database.

FIG. 8 depicts a process flow of jumping from an operation history list to a corresponding part in project data.

FIG. 9 is an example of display of a screen in which a focus is placed on a corresponding part in project data.

### DESCRIPTION OF EMBODIMENTS

Exemplary embodiments of a screen-data editing device for a programmable display device according to the present invention will be explained below in detail with reference to the accompanying drawings. These embodiments do not limit the present invention.

### Embodiment

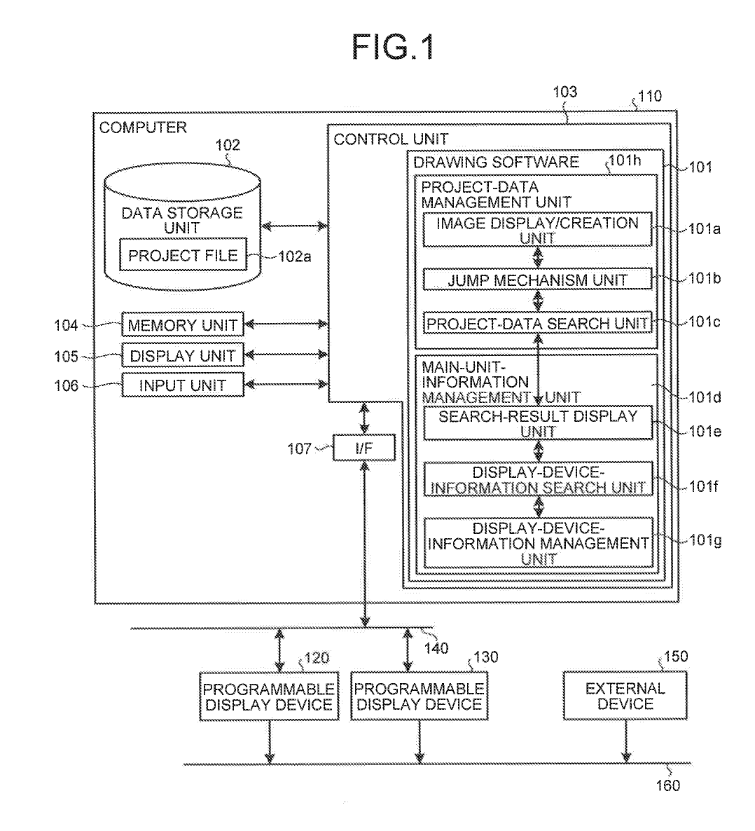

FIG. 1—depicts a configuration of a screen-data editing device for a programmable display device according to an embodiment of the present invention. The screen-data editing device for a programmable display device is formed as a computer 110 having drawing software 101 incorporated therein. The computer 110 contains a data storage unit 102, a control unit 103, a memory unit 104, a display unit 105, an input unit 106 and an interface (I/F) 107. The function as the screen-data editing device for a programmable display device is realized when the control unit 103 executes the drawing software 101. The drawing software 101 has a function of editing data of screen (screen data) displayed on a programmable display device 120 or 130 that controls an external device 150 connected thereto via a network 160 and displays statuses of the external device 150.

The data storage unit 102 has data such as a project file 102a, and a hard disk drive or a semiconductor storage device can be used for the data storage unit. The control unit 103 is an arithmetic unit that executes the drawing software 101. The memory unit 104 is used as a work area when the control unit 103 executes the drawing software 101. The display unit 105 is a display such as an LCD. The input unit 106 is an input device such as a keyboard or a pointing device. The I/F 107 is a communication interface for communicating with the programmable display device 120 or 130 via a bus 140.

As the drawing software 101 is executed, a project-data management unit 101h that creates and manages project data and a main-unit-information management unit 101d that obtains information from the programmable display device 120 or 130 and manages the information are configured in the control unit 103. The project-data management unit 101h has a screen display/creation unit 101a, a jump mechanism unit 101b, and a project-data search unit 101c. The project-data management unit 101h reads the project file 102a stored in the data storage unit 102, deploys the thus read file into the project data, and edits and manages the project data. Operation, display, compilation, and management of the screen data in the project data are performed by the screen display/creation unit 101a. The jump mechanism unit 101b and the project-data search unit 101c are described later. The main-unit-information management unit 101d has a search-result display unit 101e, a display-device-information search unit 101f and a display-device-information management unit 101g.

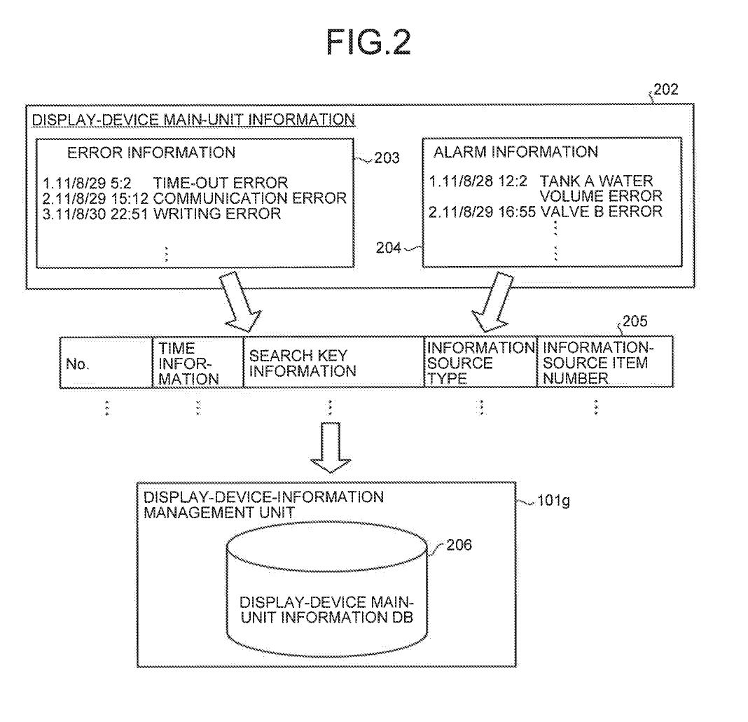

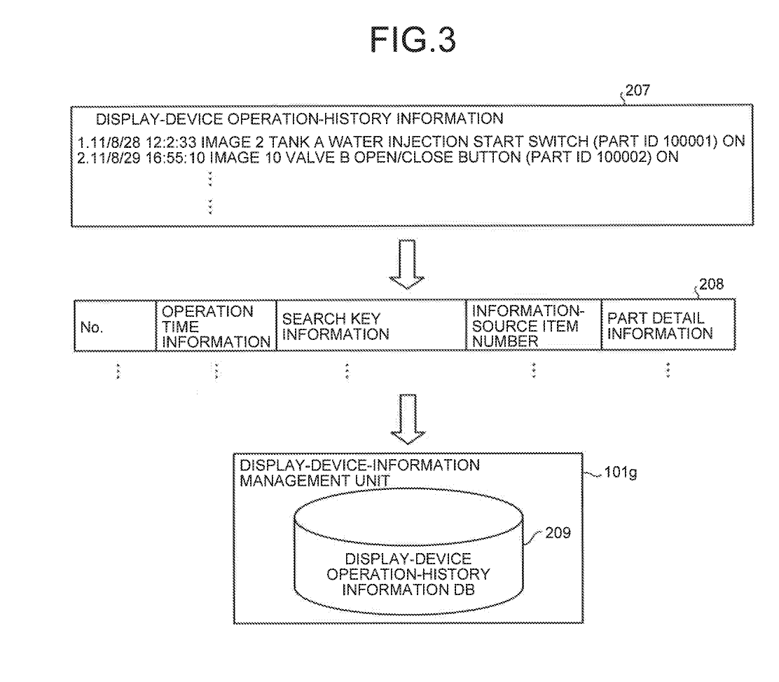

FIG. 2 depicts a process of transforming display-device main-unit information 202 read from the programmable display device 120 or 130 into a database. FIG. 3 depicts a process of transforming display-device operation-history information 207 read from the programmable display device 120 or 130 into a database. The display-device main-unit information 202 contains error information 203 and alarm information 204, wherein each item stores the time of occurrence and message information. The display-device operation-history information 207 contains information about when and which part within the project data is operated, and also detailed information (image number and ID information) regarding each part in each item thereof.

By connecting the computer 110 to the programmable display device 120 or 130 via the bus 140, the display-device main-unit information 202 and the display-device operation-history information 207 are read from the programmable display device 120 or 130 by the display-device-information management unit 101g.

The display-device-information management unit 101g extracts time information and search key information from each item of the read display-device main-unit information 202 (the error information 203 and the alarm information 204), associates a information source type (indicating from which of the error information 203 and the alarm information 204 the information is extracted) with an information-source item number indicating a data location in an extraction source, and then stores the associated information in a display-device main-unit information format 205 having fields corresponding to the information. That is, the display-device-information management unit 101g handles the display-device main-unit information format 205 thus created as one record, and manages on the memory unit 104 a display-device main-unit information database (DB) 206 containing a plurality of the records each having fields for the time information, the search key information, the information source type and the information-source item number.

The display-device-information management unit 101g extracts operation time information, search key information, detailed information about parts (image number and ID information) from each item of the read display-device operation-history information 207, associates the extracted information with an information-source item number indicating a data location in an extraction source, and stores the associated information in a display-device operation-history information format 208 having fields corresponding to the information. That is, the display-device-information management unit 101g handles the display-device operation-history information format 208 thus created as one record, and manages on the memory unit 104 a display-device operation-history information database (DB) 209 containing a plurality of the records each having the fields for the operation time information, the search key information, the information-source item number, and the detailed information regarding parts.

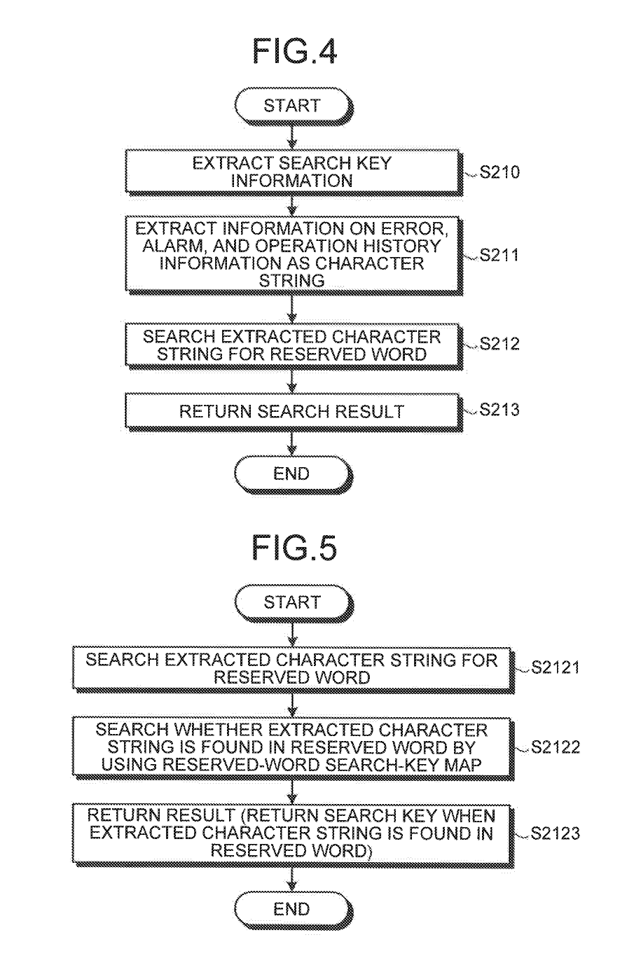

A process of extracting the search key information from the display-device main-unit information 202 or the display-device operation-history information 207 is explained next. FIG. 4 depicts a process flow of extracting the search key information from the display-device main-unit information 202 or the display-device operation-history information 207. When starting extracting the search key information (Step S210), the display-device-information management unit 101g extracts the display-device main-unit information 202 (the error information 203 and the alarm information 204) or the display-device operation-history information 207 as a character string (Step S211). The display-device-information management unit 101g then searches the extracted character string for a reserved word (Step S212), and returns a search result (Step S213).

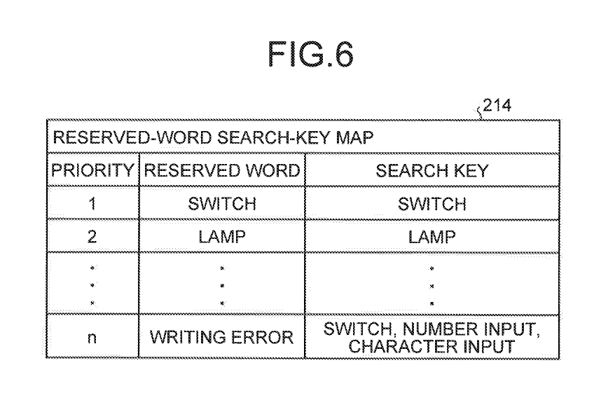

FIG. 5 depicts a process flow of searching the extracted character string for a reserved word. FIG. 6 is an example of a reserved-word search-key map. When starting the process of searching the extracted character string for the reserved word (Step S2121), the display-device-information management unit 101g searches the character string extracted from the display-device main-unit information 202 or the display-device operation-history information 207 for characters corresponding to the reserved word registered in a reserved-word search-key map 214 (Step S2122). When the reserved word is-found, the display-device-information management unit 101g obtains a search key corresponding to the thus found reserved word from the reserved-word search-key map 214, and returns the obtained search key as a search result (Step S2123).

In the reserved-word search-key map 214, one or plural search keys are allocated to each of the reserved words (names of parts used by the drawing software 101). If the reserved-word search-key map 214 has a form in which data can be added or updated afterwards, searching accuracy can be enhanced.

Operations for obtaining information from the display-device main-unit information database 206 and the display-device operation-history information database 209 managed by the display-device-information management unit 101g and for displaying the obtained information on the display unit 105 are explained next.

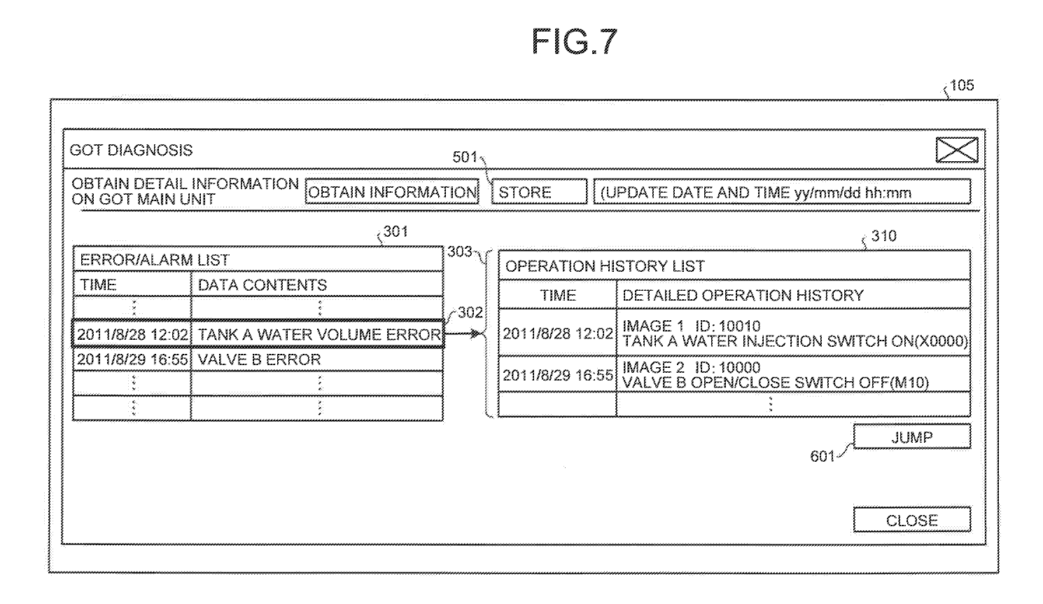

FIG. 7 is an example of display on the display unit 105 of the information that is obtained from the display-device main-unit information database 206 and the display-device history information database 209. The display-device-information search unit 10f extracts information of an error or an alarm from the display-device main-unit information database 206 managed by the display-device-information management unit 101g, and the search-result display unit 101e causes the display unit 105 to display a list of the obtained information as an error/alarm list 301. When a user selects one record on the error/alarm list 301 by an operation through the input unit 106, the display-device-information search unit 101f extracts time and search key information 302 of the selected record, and further extracts records 303 corresponding to the extracted information from the display-device operation-history information database 209.

Selection is performed in the following order. A predetermined number of records temporally close to the record selected by the user are first extracted from the error/alarm list 301, and then records having the same search key are further extracted from the extracted records. The search-result display unit 101e displays this extraction result on the display unit 105 as an operation history list 310 independently from the error/alarm list 301. When there are records more than the predetermined number, they are rearranged according to a priority order that is recorded in the reserved-word search-key map 214, so that the operation history list 310 that contains more accurate operation histories that have (quite possibly) caused a specified error or alarm can be displayed on the display unit 105.

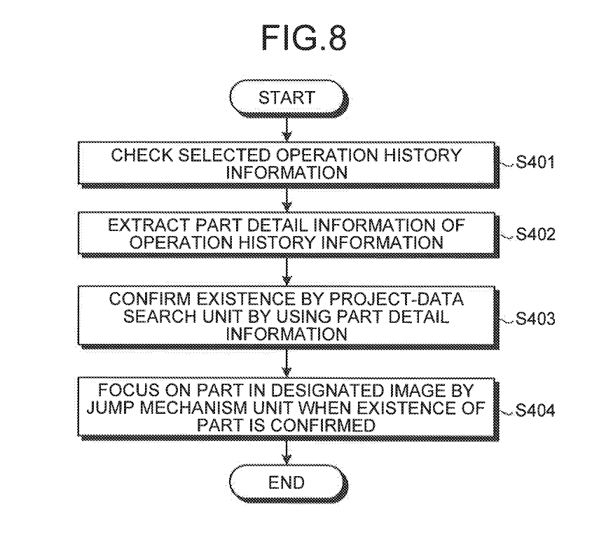

A jump from the operation history list 310 to a corresponding part in the project data is explained next. FIG. 8 depicts a process flow of jumping from the operation history list 310 to a corresponding part in the project data. The “jump” in this specification means an operation for switching the screen displayed on the display unit 105 from a screen (the operation history list 310, for example) different from a part-displaying image to a screen displaying a part in the project data. When one record is selected from the operation history list 310 in response to an operation through the input unit 106 and then a jump button 601 is pressed, the jump mechanism unit 101b starts checking the selected operation history information (Step S401). The jump mechanism unit 101b extracts detailed information regarding parts (image number and ID information) of the corresponding display-device operation-history format 208 (Step S402).

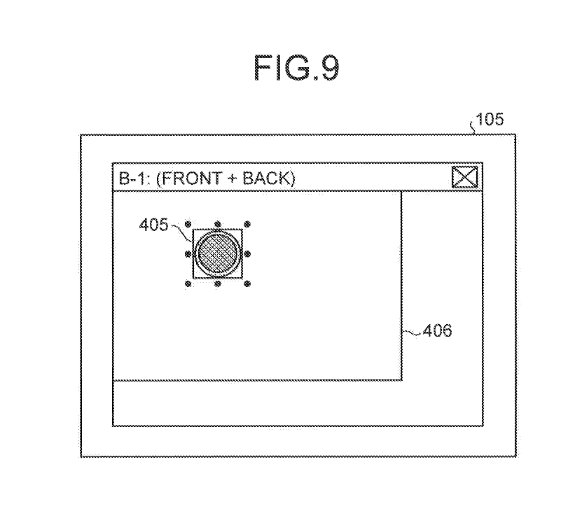

The project data includes configuration information, image information, and part information of a project. The project configuration information contains the screen information, and the screen information contains the part information. The jump mechanism unit 101b checks whether the detailed information (image number and ID information) of a part is valid (whether data exists) when executing the jump. At this time, the project-data search unit 101c checks existence of the data based on the project configuration information (Step S403). When the existence is confirmed, the jump mechanism unit 101b causes the display unit 105 to display thereon a screen 406 including the part, thereby executing the jump (S404). At this time, the jump mechanism unit 101b places a focus 405 on the corresponding part to be displayed on the display unit 105. FIG. 9 is an example of display of the screen 406 in which the focus 405 is placed on the corresponding part in the project data.

When there is no project data edited and managed by the project-data management unit 101h (when no project file 102a is stored in the data storage unit 102, for example), the jump mechanism unit 101b reads project data directly from the programmable display device 120 or 130 connected to the computer 110, and jumps to corresponding part data.

An operation for embedding the display-device main-unit information database 206 and the display-device operation-history information database 209 managed by the display-device-information management unit 101g in the project data to store the databases is explained next.

The display-device main-unit information database 206 and the display-device operation-history information database 209, which are read out from the programmable display device 120 or 130 and created, are converted to files and managed as one of project data in the drawing software 101. That is, each database is converted to a file and embedded in the project data when it is stored. At that time, current time information is also acquired and embedded in the project data together with the files. Embedding (storing) of the display-device main-unit information database 206 and the display-device operation-history information database 209 in the project data is executed when a store button 501 is pressed by a user's operation through the input unit 106.

From the next reading of information from the programmable display device 120 or 130 using the drawing software 101, when there is embedded data, the error/alarm list 301 or the operation history list 310 is displayed based on the embedded data without having communication with the programmable display device 120 or 130 via the I/F 107. By doing so, the cause of a trouble can be analyzed even when the programmable display device 120 or 130 has been removed or is not activated, thereby enabling to perform an efficient analysis of the cause.

When the programmable display device 120 or 130 is connected, the display-device-information management unit 101g may check, based on the current time information embedded in the project data, whether the display-device main-unit information or the display-device operation-history information in the programmable display device 120 or 130 has been updated, and obtain the display-device main-unit information and the display-device operation-history information only when the information has been updated. Furthermore, the display-device-information management unit 101g may obtain only data corresponding to a difference modified by the update, from the programmable display device 120 or 130.

The screen-data editing device for a programmable display device according to the present embodiment can establish a connection with a programmable display device having a trouble, read therefrom the display-device main-unit information and the display-device operation-history information, and display a list of events that are likely to be related to the trouble in such a manner that the events can be easily selected. When a user selects one of records in the displayed list to be examined, related (strongly related) information is extracted from the display-device operation-history information based on data generation time or search key information of the selected information. Furthermore, operations for obtaining location information of related part data in the project data from the extracted display-device operation-history information, reading data about the related part on the drawing software based on the obtained location information, and then placing a focus on (jumping to) the read data can be realized by a single action, and therefore it is possible to easily and quickly obtain detailed information of data regarding a record to be examined.

The display-device main-unit information and the display-device operation-history information are each managed by the drawing software as the database, and thus can be rearranged or searched by using the search key information. Therefore, the records can be rearranged or extracted according to what the user wishes to examine, so that intended target information can be easily found.

As described above, according to the present embodiment, it is possible to easily reach the related data in the project data based on the error information and the alarm information and obtain more detailed information, which reduces time required to discover the cause of a trouble.

While the example mentioned above has handled the case in which the error information and the alarm information is contained in the display-device main-unit information, data-logging information or the like can also be contained.

### INDUSTRIAL APPLICABILITY

As described above, the screen-data editing device for a programmable display device according to the present invention is useful in that, when some trouble occurs in a programmable display device or a device or a system using the programmable display device, the cause of the trouble can be easily detected.

### REFERENCE SIGNS LIST

101 DRAWING SOFTWARE

101a SCREEN DISPLAY/CREATION UNIT

101b JUMP MECHANISM UNIT

101c PROJECT-DATA SEARCH UNIT

101d MAIN-UNIT-INFORMATION MANAGEMENT UNIT

101e SEARCH-RESULT DISPLAY UNIT

101f DISPLAY-DEVICE-INFORMATION SEARCH UNIT

101g DISPLAY-DEVICE-INFORMATION MANAGEMENT UNIT

101h PROJECT-DATA MANAGEMENT UNIT

102 DATA STORAGE UNIT

102a PROJECT FILE

103 CONTROL UNIT

104 MEMORY UNIT

105 DISPLAY UNIT

106 INPUT UNIT

107 I/F

110 COMPUTER

120, 130 PROGRAMMABLE DISPLAY DEVICE

140 BUS

150 EXTERNAL DEVICE

160 NETWORK

202 DISPLAY-DEVICE MAIN-UNIT INFORMATION

203 ERROR INFORMATION

204 ALARM INFORMATION

205 DISPLAY-DEVICE MAIN-UNIT INFORMATION FORMAT

206 DISPLAY-DEVICE MAIN-UNIT INFORMATION DATABASE

207 DISPLAY-DEVICE OPERATION-HISTORY INFORMATION

208 DISPLAY-DEVICE OPERATION-HISTORY INFORMATION FORMAT

209 DISPLAY-DEVICE OPERATION-HISTORY INFORMATION DATABASE

214 RESERVED-WORD SEARCH-KEY MAP

301 ERROR/ALARM LIST

302 SEARCH KEY INFORMATION

303 RECORD

310 OPERATION HISTORY LIST

405 FOCUS

406 SCREEN

501 STORE BUTTON

601 JUMP BUTTON

1. A screen-data editing device for a programmable display device that edits screen data of a programmable display device, the screen-data editing device comprising:
a display unit that displays information;
a display-device-information management unit that reads from the programmable display device, display-device main-unit information indicating a history of information externally output from the programmable display device and display-device operation-history information indicating a history of operations performed with respect to the programmable display device, extracts a reserved word contained in the display-device main-unit information and the display-device operation-history information read from the programmable display device, and creates a display-device main-unit information database and a display-device operation-history information database that have a plurality of records each containing a field for a search key corresponding to the reserved word;
a display-device-information search unit that extracts, from the display-device operation-history information database, a record containing a same search key as that contained in a record specified from the display-device main-unit information database through a user's operation; and
a search-result display unit that causes the display unit to display as an operation history list, a list of the records extracted from the display-device operation-history information database by the display-device-information search unit.

2. The screen-data editing device for a programmable display device according to claim 1, the screen-data editing device further comprising:
a project-data search unit that searches project data for a part related to a record specified from the operation history list through a user's operation; and
a jump mechanism unit that causes the display unit to display the part extracted by the project-data search unit.

3. The screen-data editing device for a programmable display device according to claim 1, wherein the display-device-information management unit has a reserved-word search-key map in which reserved words and the search keys are associated with each other, and records the search key corresponding to a reserved word contained in the display-device main-unit information and the search key corresponding to the reserved word contained in the display-device operation-history information, in the display-device main-unit information database and the display-device operation-history information database, respectively, based on the reserved-word search-key map.

4. The screen-data editing device for a programmable display device according to claim 1, wherein the display-device-information management unit embeds the display-device main-unit information database and the display-device operation-history information database in project data to store the embedded databases.

5. The screen-data editing device for a programmable display device according to claim 4, wherein
the display-device-information management unit
embeds also current time information in the project data when embedding the display-device main-unit information database and the display-device operation-history information database in the project data,
checks based on the current time information embedded in the project data as to whether the display-device main-unit information and the display-device operation-history information in the programmable display device has been updated, when connected to the programmable display device, and
reads the display-device main-unit information and the display-device operation-history information from the programmable display device when the information has been updated.

6. The screen-data editing device for a programmable display device according to claim 1, wherein the display-device-information management unit creates the display-device main-unit information database and the display-device operation-history information database for each programmable display device.
